(19) United States
(12) Patent Application Publication
(10) Pub. No.: US 2025/0384233 A1
(43) Pub. Date: Dec. 18, 2025

(54) IMAGE FORMING APPARATUS CAPABLE OF MANAGING INK CONSUMPTION IN PAGE IMAGE UNIT, AND STORAGE METHOD

(71) Applicant: KYOCERA Document Solutions Inc., Osaka (JP)

(72) Inventor: Ryo Egami, Osaka (JP)

(21) Appl. No.: 19/033,835

(22) Filed: Jan. 22, 2025

(30) Foreign Application Priority Data
Jan. 23, 2024 (JP) 2024-007907

(51) Int. Cl. G06K 15/00; B41J 2/175; B41J 29/00; G06K 15/10

(52) U.S. Cl. CPC G06K 15/4075; B41J 2/17566; B41J 29/00; G06K 15/102; B41J 2002/17569

(57) ABSTRACT

An image forming apparatus includes a sheet conveying portion, an execution processing portion, an acquisition processing portion, and a storage processing portion. The sheet conveying portion conveys sheets. The execution processing portion executes image forming processing for forming a page image on each of the sheets sequentially conveyed by the sheet conveying portion. The acquisition processing portion acquires an ink consumption used for forming the page image for each of the page images formed by the image forming processing. The storage processing portion stores the ink consumption acquired by the acquisition processing portion in a predetermined first storage portion.

### INCORPORATION BY REFERENCE

This application is based upon and claims the benefit of priority from the corresponding Japanese Patent Application No. 2024-007907 filed on Jan. 23, 2024, the entire contents of which are incorporated herein by reference.

### BACKGROUND

The present disclosure relates to an image forming apparatus and a storage method.

There is known an image forming apparatus capable of forming an image using an inkjet system. In addition, the image forming apparatus capable of calculating an ink consumption is known as the related art.

### SUMMARY

An image forming apparatus according to an aspect of the present disclosure includes a sheet conveying portion, an execution processing portion, an acquisition processing portion, and a storage processing portion. The sheet conveying portion conveys sheets. The execution processing portion executes image forming processing for forming a page image on each of the sheets sequentially conveyed by the sheet conveying portion. The acquisition processing portion acquires an ink consumption used for forming the page image for each of the page images formed by the image forming processing. The storage processing portion stores the ink consumption acquired by the acquisition processing portion in a predetermined first storage portion.

A storage method according to another aspect of the present disclosure is executed in an image forming apparatus including a sheet conveying portion which conveys sheets, and includes an execution step, an acquisition step, and a storage step. The execution step includes executing image forming processing for forming a page image on each of the sheets sequentially conveyed by the sheet conveying portion. The acquisition step includes acquiring an ink consumption used for forming the page image for each of the page images formed by the image forming processing. The storage step includes storing the ink consumption acquired in the acquisition step in a predetermined first storage portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure;

FIG. 2 is a diagram showing configurations of an image forming portion and a conveying unit in the image forming apparatus according to the embodiment of the present disclosure;

FIG. 3 is a diagram showing a configuration in a periphery of a nozzle in the image forming apparatus according to the embodiment of the present disclosure;

FIG. 4 is a block diagram showing a system configuration of the image forming apparatus according to the embodiment of the present disclosure;

FIG. 5 is a flowchart showing an example of first acquisition processing executed by a head control portion of the image forming apparatus according to the embodiment of the present disclosure;

FIG. 6 is a flowchart showing an example of second acquisition processing executed by a video control portion of the image forming apparatus according to the embodiment of the present disclosure; and

FIG. 7 is a flowchart showing an example of storage processing executed by a main control portion of the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

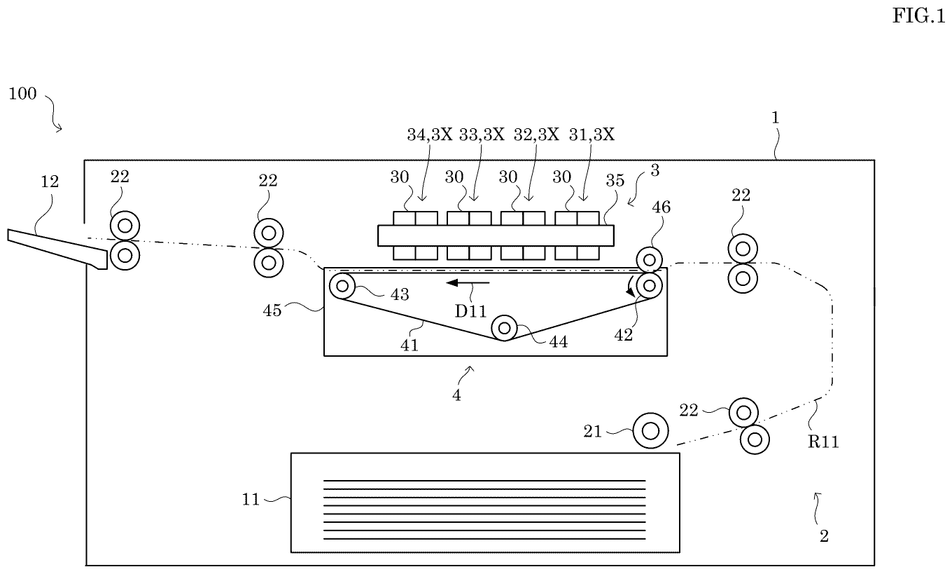

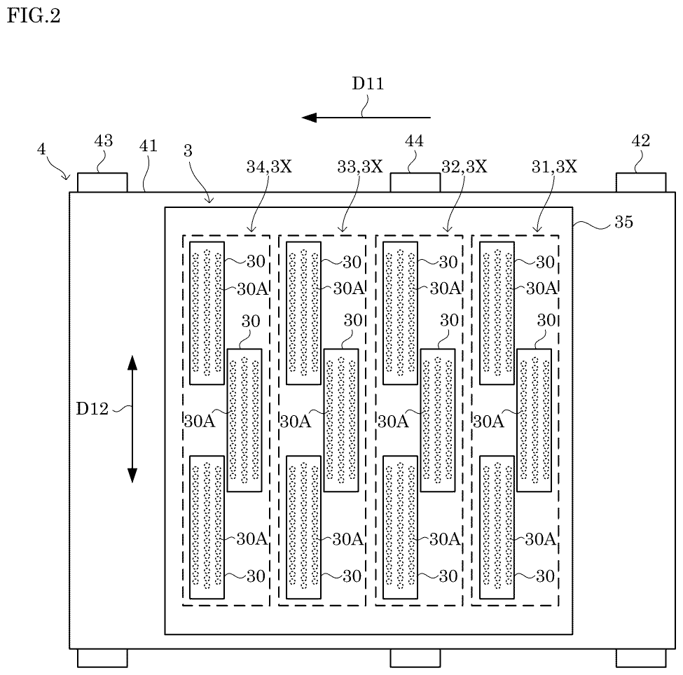

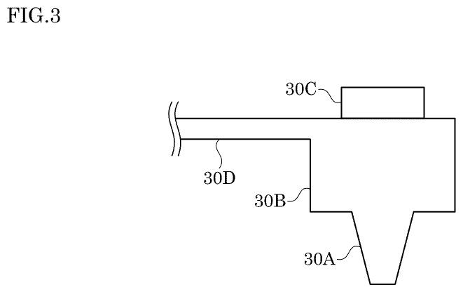

First, a configuration of an image forming apparatus 100 according to the embodiment of the present disclosure will be described with reference to FIG. 1 to FIG. 4. Herein, FIG. 1 is a cross-sectional view showing the configuration of the image forming apparatus 100. Further, FIG. 2 is a plan view showing configurations of an image forming portion 3 and a conveying unit 4. Furthermore, FIG. 3 is a cross-sectional view showing configurations of a nozzle 30A, a pressurization chamber 30B, a piezoelectric element 30C, and an individual flow path 30D. It is noted that in FIG. 1, a sheet conveying path R11 is indicated by a dash-dot-dot line.

The image forming apparatus 100 is a printer that is capable of forming an image on a sheet using an inkjet system. It is noted that the present disclosure may also be applied to a facsimile apparatus, a copying machine, a multifunction peripheral, or the like that is capable of forming an image on a sheet using the inkjet system.

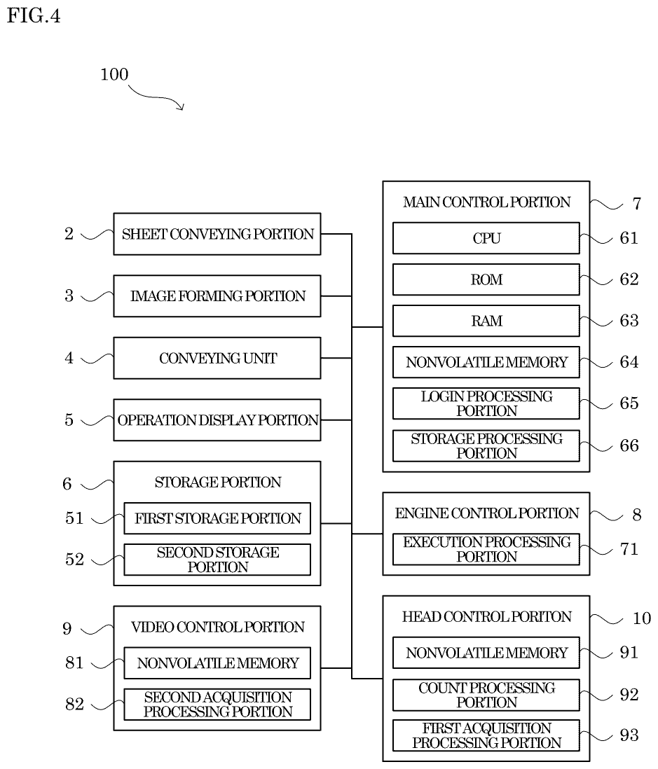

As shown in FIG. 1 and FIG. 4, the image forming apparatus 100 includes a housing 1, a sheet conveying portion 2, the image forming portion 3, the conveying unit 4, an operation display portion 5, a storage portion 6, a main control portion 7, an engine control portion 8, a video control portion 9, and a head control portion 10.

The housing 1 accommodates respective constituent elements of the image forming apparatus 100. A sheet feed cassette 11 (see FIG. 1) is detachably provided in the housing 1. The sheet feed cassette 11 stores sheets on each of which an image is to be formed. A sheet discharge tray 12 (an example of a sheet discharge portion according to the present disclosure) (see FIG. 1) is provided on an outer side surface of the housing 1. The sheet on which an image has been formed by the image forming portion 3 is discharged onto the sheet discharge tray 12. Inside the housing 1, the sheet stored in the sheet feed cassette 11 is conveyed along the sheet conveying path R11 (see FIG. 1) that reaches the sheet discharge tray 12 via an image forming position of the image forming portion 3.

The sheet conveying portion 2 conveys the sheet stored in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 takes out an uppermost sheet out of a batch of sheets stored in the sheet feed cassette 11, and feeds the sheet to the sheet conveying path R11. The plurality of conveying rollers 22 are provided so as to be aligned along the sheet conveying path R11. Each of the conveying rollers 22 conveys the sheet along the sheet conveying path R11. Each of the conveying rollers 22 conveys the sheet in a conveying direction D11 (see FIG. 1) that is directed from the sheet feed cassette 11 toward the sheet discharge tray 12.

The image forming portion 3 forms an ink image on the sheet conveyed by the sheet conveying portion 2. As shown in FIG. 1, the image forming portion 3 includes four line heads 3X (31 to 34) and a head frame 35.

As shown in FIG. 2, each of the line heads 3X is elongated in a width direction D12 orthogonal to the conveying direction D11. Specifically, each of the line heads 3X has, in the width direction D12, a length corresponding to a width of a sheet of a maximum size out of the sheets that can be stored in the sheet feed cassette 11. The four line heads 3X are provided so as to be aligned at regular intervals along the conveying direction D11.

As shown in FIG. 2, each of the line heads 3X includes a plurality of recording heads 30. Each of the recording heads 30 discharges ink droplets toward the sheet conveyed by the conveying unit 4. Each of the recording heads 30 provided in the line head 31 discharges black ink droplets. Each of the recording heads 30 provided in the line head 32 discharges cyan ink droplets. Each of the recording heads 30 provided in the line head 33 discharges magenta ink droplets. Each of the recording heads 30 provided in the line head 34 discharges yellow ink droplets.

Each of the recording heads 30 includes a plurality of nozzles 30A (see FIG. 2 and FIG. 3) that discharge ink droplets onto a sheet. Each of the nozzles 30A is provided on an opposing surface of the recording head 30 that opposes the sheet conveyed by the conveying unit 4. For example, in the image forming apparatus 100, ink droplets of a small size, a medium size, or a large size are discharged from the nozzles 30A.

Further, each of the recording heads 30 includes the pressurization chambers 30B (see FIG. 3), the piezoelectric elements 30C (see FIG. 3), and the individual flow paths 30D (see FIG. 3) that respectively correspond to the nozzles 30A. The pressurization chamber 30B is in communication with the nozzle 30A and stores ink. The piezoelectric element 30C varies a pressure in the pressurization chamber 30B in accordance with an input of a driving voltage to cause the ink droplets to be discharged from the nozzle 30A. The individual flow path 30D is an ink flow path provided between the pressurization chamber 30B and a common flow path (not shown) common to the plurality of nozzles 30A. The plurality of individual flow paths 30D respectively corresponding to the plurality of nozzles 30A are connected to the common flow path. The common flow path is connected to an ink supplying portion (not shown) that supplies the ink to each of the pressurization chambers 30B.

Each of the line heads 3X includes three recording heads 30 that are arranged in a staggered pattern along the width direction D12. It is noted that the number of recording heads 30 to be provided in each of the line heads 3X may be an arbitrary number.

The head frame 35 supports the four line heads 3X. The head frame 35 is supported by the housing 1. It is noted that the number of line heads 3X to be provided in the image forming portion 3 may be an arbitrary number including one.

As shown in FIG. 1, the conveying unit 4 is arranged below the four line heads 3X. The conveying unit 4 conveys the sheet while causing the sheet to oppose the recording heads 30. For example, the conveying unit 4 conveys the sheet by a predetermined conveying amount every time the discharge of the ink droplets is performed by the recording head 30. Further, while the discharge of the ink droplets is performed by the recording head 30, the conveying unit 4 stops the conveyance of the sheet. As shown in FIG. 1, the conveying unit 4 includes a conveying belt 41 on which the sheet is to be placed, a first tension roller 42, a second tension roller 43, and a third tension roller 44 across which the conveying belt 41 is stretched, and a conveying frame 45 that supports these. It is noted that a gap between the conveying belt 41 and the recording heads 30 is adjusted such that a gap between a surface of the sheet and the recording heads 30 during image formation becomes a predetermined distance (for example, 1 mm).

The first tension roller 42 is rotationally driven by a rotational driving force supplied from a motor (not shown). Thus, the conveying belt 41 rotates in a direction in which the sheet can be conveyed in the conveying direction D11 (see FIG. 1). It is noted that the conveying unit 4 is also provided with a suction unit (not shown) or the like that sucks in air via a large number of through-holes formed in the conveying belt 41 to cause the sheet to stick to the conveying belt 41. Further, a pressure roller 46 for conveying the sheet while pressing the sheet against the conveying belt 41 is provided above the first tension roller 42.

The operation display portion 5 includes a display portion such as a liquid crystal display that displays various types of information in response to control instructions from the main control portion 7 and an operation portion such as an operation key or a touch panel that is used for inputting various types of information to the main control portion 7 in accordance with user operations.

The storage portion 6 is a nonvolatile storage device. For example, the storage portion 6 is a nonvolatile memory such as a flash memory.

The main control portion 7 collectively controls the image forming apparatus 100. As shown in FIG. 4, the main control portion 7 includes a CPU 61, a ROM 62, a RAM 63, and a nonvolatile memory 64. The CPU 61 is a processor that executes various types of arithmetic processing. The ROM 62 is a nonvolatile storage device in which information such as control programs for causing the CPU 61 to execute various types of processing is stored in advance. The RAM 63 is a volatile or nonvolatile storage device that is used as a temporary storage memory (working area) for the various type of processing to be executed by the CPU 61. The nonvolatile memory 64 is a nonvolatile storage device. The CPU 61 executes the various control programs stored in advance in the ROM 62, to thus collectively control the image forming apparatus 100.

The engine control portion 8 controls each of the sheet conveying portion 2, the image forming portion 3, the conveying unit 4, the video control portion 9, and the head control portion 10. For example, the engine control portion 8 is constituted of an electronic circuit such as an integrated circuit (ASIC, DSP).

The video control portion 9 executes image processing on image data corresponding to one page of a print target document sheet. For example, the image processing includes decomposition processing for decomposing the image data into pieces of color image data respectively corresponding to the colors of black, cyan, magenta, and yellow. Further, the image processing includes conversion processing for converting each pixel data included in the color image data into either discharge pixel data used for discharge of the ink droplets from the nozzles 30A corresponding to the pixel data or non-discharge pixel data used for non-discharge of the ink droplets from the nozzles 30A corresponding to the pixel data. For example, the video control portion 9 is constituted of an electronic circuit such as an integrated circuit (ASIC, DSP). As shown in FIG. 4, the video control portion 9 includes a nonvolatile memory 81. The nonvolatile memory 81 is a nonvolatile storage device.

The head control portion 10 is provided in correspondence with each of the line heads 3X of the image forming portion 3. Each of the head control portions 10 controls discharge of the ink droplets by the line head 3X based on the color image data subjected to the conversion processing, that is input from the video control portion 9. For example, the head control portion 10 is constituted of an electronic circuit such as an integrated circuit (ASIC, DSP). As shown in FIG. 4, the head control portion 10 includes a nonvolatile memory 91. The nonvolatile memory 91 is a nonvolatile storage device.

Incidentally, an image forming apparatus capable of calculating an ink consumption is known as the related art.

In the image forming apparatus according to the related art described above, however, the ink consumption cannot be managed in a unit of a page image formed on a sheet.

In contrast, in the image forming apparatus 100 according to the embodiment of the present disclosure, the ink consumption can be managed in the page image unit as will be described below.

Specifically, the main control portion 7 includes a login processing portion 65 and a storage processing portion 66 shown in FIG. 4. The CPU 61 of the main control portion 7 executes the control program stored in advance in the ROM 62 to thus function as the respective processing portions described above.

Further, the engine control portion 8 includes an execution processing portion 71 shown in FIG. 4.

Further, the video control portion 9 includes a second acquisition processing portion 82 shown in FIG. 4.

Furthermore, each of the head control portions 10 includes a count processing portion 92 and a first acquisition processing portion 93 shown in FIG. 4.

The login processing portion 65 executes login processing for authenticating a user in accordance with a predetermined authentication operation.

For example, the login processing portion 65 causes the operation display portion 5 to display an authentication screen for performing the authentication operation as necessary. Then, the login processing portion 65 accepts the authentication operation by the user in the authentication screen. For example, the authentication operation is an input operation of a user name and a password. The login processing portion 65 authenticates the user based on the information input by the authentication operation. Specifically, when the input information matches information corresponding to the user that is registered in advance in the image forming apparatus 100, the login processing portion 65 determines authentication completion and allows the user to log in to the image forming apparatus 100. It is noted that the login processing portion 65 executes logout processing for causing the currently logged-in user to log out in a case where a logout operation with respect to the operation display portion 5 is made, in a case where a preset time has elapsed, or in a case where another user is to log in.

The execution processing portion 71 executes image forming processing for forming the page image on each of the sheets sequentially conveyed by the sheet conveying portion 2. The page image is an image corresponding to one page of a print target document sheet.

Specifically, in the image forming processing, the sheets stored in the sheet feed cassette 11 are sequentially conveyed by the sheet conveying portion 2 and the conveying unit 4. Further, in the image forming processing, one or a plurality of pieces of the image data corresponding to the print target document sheet is/are sequentially input to the video control portion 9, and the video control portion 9 executes the image processing on the input image data. Moreover, in the image forming processing, the color image data that has been subjected to the conversion processing is input from the video control portion 9 to each of the head control portions 10, and each of the head control portions 10 performs discharge of the ink from the line head 3X that is based on the input color image data.

The count processing portion 92 corresponding to the line head 31 counts the number of times of discharge of the ink droplets of each size from each of the nozzles 30A included in the line head 31 during a forming period of the page image. The page image forming period is a period from a start time of the discharge of the ink droplets based on the color image data by the line head 31 to an end time of the discharge of the ink droplets based on the color image data by the line head 34.

The count processing portion 92 corresponding to the line head 32 counts the number of times of discharge of the ink droplets of each size from each of the nozzles 30A included in the line head 32 during the page image forming period.

The count processing portion 92 corresponding to the line head 33 counts the number of times of discharge of the ink droplets of each size from each of the nozzles 30A included in the line head 33 during the page image forming period.

The count processing portion 92 corresponding to the line head 34 counts the number of times of discharge of the ink droplets of each size from each of the nozzles 30A included in the line head 34 during the page image forming period.

The first acquisition processing portion 93 corresponding to the line head 31 acquires an ink consumption of black ink used for forming the page image for each of the page images formed by the image forming processing. Specifically, the first acquisition processing portion 93 corresponding to the line head 31 acquires the ink consumption of black ink used for forming the page image based on a result of the count by the count processing portion 92 corresponding to the line head 31.

The first acquisition processing portion 93 corresponding to the line head 32 acquires an ink consumption of cyan ink used for forming the page image for each of the page images formed by the image forming processing. Specifically, the first acquisition processing portion 93 corresponding to the line head 32 acquires the ink consumption of cyan ink used for forming the page image based on a result of the count by the count processing portion 92 corresponding to the line head 32.

The first acquisition processing portion 93 corresponding to the line head 33 acquires an ink consumption of magenta ink used for forming the page image for each of the page images formed by the image forming processing. Specifically, the first acquisition processing portion 93 corresponding to the line head 33 acquires the ink consumption of magenta ink used for forming the page image based on a result of the count by the count processing portion 92 corresponding to the line head 33.

The first acquisition processing portion 93 corresponding to the line head 34 acquires an ink consumption of yellow ink used for forming the page image for each of the page images formed by the image forming processing. Specifically, the first acquisition processing portion 93 corresponding to the line head 34 acquires the ink consumption of yellow ink used for forming the page image based on a result of the count by the count processing portion 92 corresponding to the line head 34.

The second acquisition processing portion 82 acquires, for each of the page images formed by the image forming processing, the ink consumption of each of the ink of the four colors used for forming the page image.

Specifically, the second acquisition processing portion 82 acquires the ink consumptions of the ink of the four colors used for forming the page image from the four first acquisition processing portions 93 respectively corresponding to the four line heads 3X. The four first acquisition processing portions 93 and the second acquisition processing portion 82 are an example of an acquisition processing portion according to the present disclosure.

The storage processing portion 66 stores, in a first storage portion 51 (see FIG. 4) of the storage portion 6, the ink consumptions of the ink of the four colors used for forming the page image, that are acquired by the second acquisition processing portion 82.

Further, the storage processing portion 66 stores, in a second storage portion 52 (see FIG. 4) of the storage portion 6, ink consumptions of the ink of the four colors corresponding to a sheet for which the image forming processing has been interrupted before being discharged onto the sheet discharge tray 12.

The first storage portion 51 is a preset storage area in the storage portion 6. Further, the second storage portion 52 is a storage area that is set separately from the first storage portion 51 in the storage portion 6. For example, the first storage portion 51 is provided for each of the users capable of logging in to the image forming apparatus 100.

For example, the storage processing portion 66 stores the ink consumptions of the ink of the four colors used for forming the page image, that are acquired by the second acquisition processing portion 82, in the first storage portion 51 corresponding to the currently logged-in user.

In the image forming apparatus 100, during execution of the image forming processing by the execution processing portion 71, first acquisition processing, second acquisition processing, and storage processing described below are executed. The execution of the image forming processing by the execution processing portion 71 is an example of an execution step included in a storage method according to the present disclosure.

### [First Acquisition Processing]

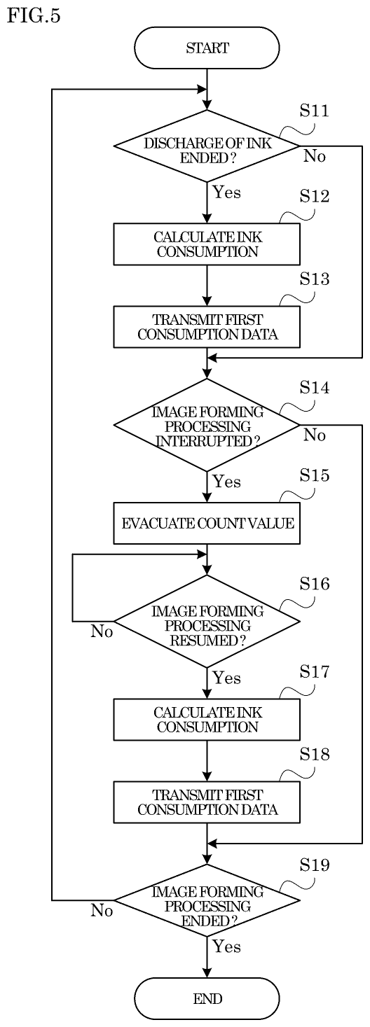

Next, exemplary procedures of first acquisition processing executed by the first acquisition processing portion 93 corresponding to the line head 31 will be described with reference to FIG. 5. Herein, Step S11, Step S12, . . . represent numbers of processing procedures (steps) executed by the first acquisition processing portion 93. It is noted that the first acquisition processing portions 93 respectively corresponding to the line heads 32 to 34 also execute processing similar to processing described below.

### <Step S11>

First, in Step S11, the first acquisition processing portion 93 determines whether or not discharge of ink droplets by the line head 31, that is based on the color image data of black has ended.

Herein, when determining that the discharge of the ink droplets by the line head 31 has ended (Yes in S11), the first acquisition processing portion 93 shifts the processing to Step S12. On the other hand, when determining that the discharge of the ink droplets by the line head 31 has not ended (No in S11), the first acquisition processing portion 93 shifts the processing to Step S14.

### <Step S12>

In Step S12, the first acquisition processing portion 93 calculates the ink consumption of black ink used for forming the page image.

Specifically, the first acquisition processing portion 93 aggregates the count result of the number of times of discharge of the ink droplets of each size from each of the nozzles 30A included in the line head 31, that is obtained by the count processing portion 92 corresponding to the line head 31. Then, the first acquisition processing portion 93 calculates the ink consumption of the black ink used for forming the page image based on the aggregated result and the ink amounts corresponding to the respective sizes of the ink droplets.

### <Step S13>

In Step S13, the first acquisition processing portion 93 transmits first consumption data including the ink consumption calculated by the processing of Step S12 to the video control portion 9. For example, the first consumption data includes first identification information such as an identification ID used for identifying the first consumption data. For example, the first identification information is generated by the first acquisition processing portion 93.

### <Step S14>

In Step S14, the first acquisition processing portion 93 determines whether or not the image forming processing has been interrupted during the discharge of the ink droplets by the line head 31, that is based on the color image data of black.

For example, in the image forming apparatus 100, the image forming processing is interrupted when an error such as a paper jam is detected.

Herein, when determining that the image forming processing has been interrupted during the discharge of the ink droplets by the line head 31 (Yes in S14), the first acquisition processing portion 93 shifts the processing to Step S15. On the other hand, when determining that the image forming processing has not been interrupted during the discharge of the ink droplets by the line head 31 (No in S14), the first acquisition processing portion 93 shifts the processing to Step S19.

### <Step S15>

In Step S15, the first acquisition processing portion 93 evacuates the count value obtained by the count processing portion 92 corresponding to the line head 31 to the nonvolatile memory 91. Thus, it is possible to avoid a situation where data for calculating the ink consumption will be lost when the image forming processing is interrupted due to a power outage, for example.

### <Step S16>

In Step S16, the first acquisition processing portion 93 determines whether or not the image forming processing has been resumed.

Herein, when determining that the image forming processing has been resumed (Yes in S16), the first acquisition processing portion 93 shifts the processing to Step S17. On the other hand, when determining that the image forming processing has not been resumed (No in S16), the first acquisition processing portion 93 waits for the resumption of the image forming processing in Step S16.

### <Step S17>

In Step S17, the first acquisition processing portion 93 calculates the ink consumption of the black ink used for forming the page image for which the image formation has been interrupted, based on the count value evacuated to the nonvolatile memory 91 by the processing of Step S15.

### <Step S18>

In Step S18, the first acquisition processing portion 93 transmits the first consumption data including the ink consumption of the black ink that has been calculated by the processing of Step S17 to the video control portion 9.

### <Step S19>

In Step S19, the first acquisition processing portion 93 determines whether or not the image forming processing has ended.

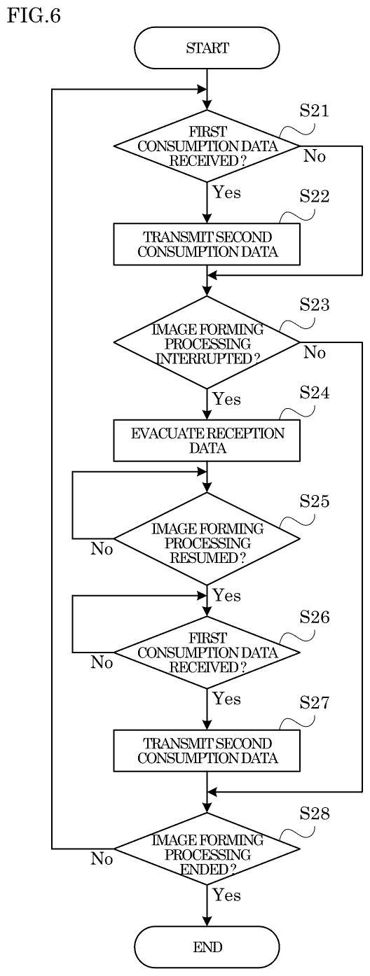

Herein, when determining that the image forming processing has ended (Yes in S19), the first acquisition processing portion 93 ends the first acquisition processing. On the other hand, when determining that the image forming processing has not ended (No in S19), the first acquisition processing portion 93 shifts the processing to Step S11.

[Second acquisition processing] Next, exemplary procedures of second acquisition processing executed by the second acquisition processing portion 82 will be described with reference to FIG. 6.

### <Step S21>

First, in Step S21, the second acquisition processing portion 82 determines whether or not four pieces of the first consumption data respectively including the ink consumptions of the ink of the four colors used for forming the page image have been received.

Herein, when determining that the four pieces of first consumption data have been received (Yes in S21), the second acquisition processing portion 82 shifts the processing to Step S22. On the other hand, when determining that the four pieces of first consumption data have not been received (No in S21), the second acquisition processing portion 82 shifts the processing to Step S23. The processing of receiving, by the second acquisition processing portion 82, the four pieces of first consumption data respectively including the ink consumptions of the ink of the four colors used for forming the page image is an example of an acquisition step included in the storage method according to the present disclosure.

### <Step S22>

In Step S22, the second acquisition processing portion 82 transmits second consumption data including the received four pieces of first consumption data to the main control portion 7. For example, the second consumption data includes second identification information such as an identification ID used for identifying the second consumption data. For example, the second identification information is generated by the second acquisition processing portion 82.

### <Step S23>

In Step S23, the second acquisition processing portion 82 determines whether or not the image forming processing has been interrupted during the page image forming period.

Herein, when determining that the image forming processing has been interrupted during the page image forming period (Yes in S23), the second acquisition processing portion 82 shifts the processing to Step S24. On the other hand, when determining that the image forming processing has not been interrupted during the page image forming period (No in S23), the second acquisition processing portion 82 shifts the processing to Step S28.

### <Step S24>

In Step S24, the second acquisition processing portion 82 evacuates, to the nonvolatile memory 81, the first consumption data that has already been received out of the four pieces of first consumption data respectively including the ink consumptions of the ink of the four colors used for forming the page image. Thus, it is possible to avoid a situation where data related to the ink consumption will be lost when the image forming processing is interrupted due to a power outage, for example.

### <Step S25>

In Step S25, the second acquisition processing portion 82 determines whether or not the image forming processing has been resumed.

Herein, when determining that the image forming processing has been resumed (Yes in S25), the second acquisition processing portion 82 shifts the processing to Step S26. On the other hand, when determining that the image forming processing has not been resumed (No in S25), the second acquisition processing portion 82 waits for the resumption of the image forming processing in Step S25.

### <Step S26>

In Step S26, the second acquisition processing portion 82 determines whether or not all pieces of the unreceived first consumption data have been received out of the four pieces of first consumption data respectively including the ink consumptions of the ink of the four colors used for forming the page image.

Herein, when determining that all pieces of the unreceived first consumption data have been received (Yes in S26), the second acquisition processing portion 82 shifts the processing to Step S27. On the other hand, when determining that all pieces of the unreceived first consumption data have not been received (No in S26), the second acquisition processing portion 82 waits for the reception of all pieces of the unreceived first consumption data in Step S26.

### <Step S27>

In Step S27, the second acquisition processing portion 82 transmits, to the main control portion 7, the second consumption data including one or a plurality of pieces of the first consumption data that has/have been evacuated by the processing of Step S24 and one or a plurality of pieces of the first consumption data that has/have been received after resumption of the image forming processing.

### <Step S28>

In Step S28, the second acquisition processing portion 82 determines whether or not the image forming processing has ended.

Herein, when determining that the image forming processing has ended (Yes in S28), the second acquisition processing portion 82 ends the second acquisition processing. On the other hand, when determining that the image forming processing has not ended (No in S28), the second acquisition processing portion 82 shifts the processing to Step S21.

### [Storage Processing]

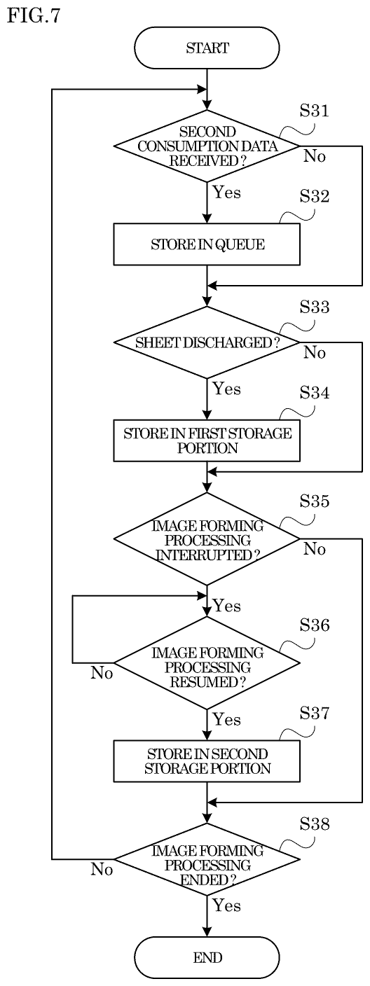

Next, exemplary procedures of storage processing executed by the storage processing portion 66 will be described with reference to FIG. 7.

### <Step S31>

First, in Step S31, the storage processing portion 66 determines whether or not the second consumption data transmitted from the video control portion 9 has been received.

Herein, when determining that the second consumption data has been received (Yes in S31), the storage processing portion 66 shifts the processing to Step S32. On the other hand, when determining that the second consumption data has not been received (No in S31), the storage processing portion 66 shifts the processing to Step S33.

### <Step S32>

In Step S32, the storage processing portion 66 stores the second consumption data transmitted from the video control portion 9 in a queue provided in the nonvolatile memory 64.

### <Step S33>

In Step S33, the storage processing portion 66 determines whether or not the sheet conveyed by the sheet conveying portion 2 has been discharged onto the sheet discharge tray 12.

Specifically, the storage processing portion 66 determines whether or not the sheet has been discharged onto the sheet discharge tray 12 using a discharge sensor (not shown) that is capable of detecting discharge of a sheet onto the sheet discharge tray 12.

Herein, when determining that the sheet has been discharged onto the sheet discharge tray 12 (Yes in S33), the storage processing portion 66 shifts the processing to Step S34. On the other hand, when determining that the sheet has not been discharged onto the sheet discharge tray 12 (No in S33), the storage processing portion 66 shifts the processing to Step S35.

### <Step S34>

In Step S34, the storage processing portion 66 stores, in the first storage portion 51 corresponding to the currently logged-in user, the second consumption data that has been stored first out of one or a plurality of pieces of the second consumption data stored in the queue. The processing of Step S34 is an example of a storage step included in the storage method according to the present disclosure.

### <Step S35>

In Step S35, the storage processing portion 66 determines whether or not the image forming processing has been interrupted.

Herein, when determining that the image forming processing has been interrupted (Yes in S35), the storage processing portion 66 shifts the processing to Step S36. On the other hand, when determining that the image forming processing has not been interrupted (No in S35), the storage processing portion 66 shifts the processing to Step S38.

### <Step S36>

In Step S36, the storage processing portion 66 determines whether or not the image forming processing has been resumed.

Herein, when determining that the image forming processing has been resumed (Yes in S36), the storage processing portion 66 shifts the processing to Step S37. On the other hand, when determining that the image forming processing has not been resumed (No in S36), the storage processing portion 66 waits for the resumption of the image forming processing in Step S36.

### <Step S37>

In Step S37, the storage processing portion 66 stores all pieces of the second consumption data stored in the queue in the second storage portion 52. In addition, when the image forming processing is interrupted during the page image forming period, the storage processing portion 66 stores the second consumption data that is to be transmitted first after the resumption of the image forming processing in the second storage portion 52. Thus, it is possible to distinctively manage the ink consumption used for forming the page image that has been printed normally and the ink consumption used for forming the page image that has not been printed normally.

### <Step S38>

In Step S38, the storage processing portion 66 determines whether or not the image forming processing has ended.

Herein, when determining that the image forming processing has ended (Yes in S38), the storage processing portion 66 ends the storage processing. On the other hand, when determining that the image forming processing has not ended (No in S38), the storage processing portion 66 shifts the processing to Step S31.

In this manner, in the image forming apparatus 100, the ink consumptions used for forming the page image are acquired for each of the page images, and the acquired ink consumptions are stored in the first storage portion 51. Thus, the ink consumptions can be managed in the page image unit.

Further, in the image forming apparatus 100, the ink consumption of the ink used for forming the page image is acquired based on the count result of the number of times of discharge of the ink droplets of each size from each of the nozzles 30A during the page image forming period. Thus, when the image forming processing is interrupted during the page image forming period, the ink consumption up to the time of interruption can be acquired.

It is noted that the first acquisition processing portion 93 may acquire the ink consumptions of the ink used for purposes other than printing. For example, when purge processing for causing the ink to be discharged from the nozzles 30A is executed, the first acquisition processing portion 93 only needs to acquire the ink consumptions of the ink discharged by the purge processing. In addition, the first acquisition processing portion 93 only needs to transmit third consumption data including the ink consumptions of the ink used for purposes other than printing to the main control portion 7. For example, the third consumption data includes third identification information such as an identification ID used for identifying the third consumption data. For example, the third identification information is generated by the first acquisition processing portion 93. Moreover, when the third consumption data transmitted from the head control portion 10 is received, the storage processing portion 66 only needs to store the received third consumption data in a third storage portion different from the first storage portion 51 and the second storage portion 52 in the storage portion 6.

Further, the second acquisition processing portion 82 may acquire the ink consumptions of the ink of the four colors used for forming the page image based on the four pieces of color image data used for forming the page image.

Furthermore, the functions of the engine control portion 8 and the functions of the video control portion 9 may be realized by the CPU 61 of the main control portion 7. In this case, the CPU 61 only needs to execute the control program to thus function as the execution processing portion 71 and the second acquisition processing portion 82.

### Notes of Disclosure

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including: a sheet conveying portion which conveys sheets; an execution processing portion which executes image forming processing for forming a page image on each of the sheets sequentially conveyed by the sheet conveying portion; an acquisition processing portion which acquires an ink consumption used for forming the page image for each of the page images formed by the image forming processing; and a storage processing portion which stores the ink consumption acquired by the acquisition processing portion in a predetermined first storage portion.

### <Note 2>

The image forming apparatus according to note 1, including: a plurality of nozzles which discharge ink droplets onto the sheet conveyed by the sheet conveying portion; and a count processing portion which counts a number of times of discharge of the ink droplets of each of the nozzles during a forming period of the page image, in which the acquisition processing portion acquires the ink consumption based on a result of the count by the count processing portion.

### <Note 3>

The image forming apparatus according to note 1 or 2, including: a sheet discharge portion onto which the sheet on which the page image has been formed is discharged, in which the storage processing portion stores the ink consumption corresponding to the sheet for which the image forming processing has been interrupted before being discharged onto the sheet discharge portion in a second storage portion different from the first storage portion.

### <Note 4>

The image forming apparatus according to any one of notes 1 to 3, including: a login processing portion which causes users to log in, in which the first storage portion is provided for each of the users who are capable of logging in to the image forming apparatus, and the storage processing portion stores the ink consumption acquired by the acquisition processing portion in the first storage portion corresponding to the user who is currently logged in.

### <Note 5>

A storage method executed in an image forming apparatus including a sheet conveying portion which conveys sheets, including: an execution step of executing image forming processing for forming a page image on each of the sheets sequentially conveyed by the sheet conveying portion; an acquisition step of acquiring an ink consumption used for forming the page image for each of the page images formed by the image forming processing; and a storage step of storing the ink consumption acquired in the acquisition step in a predetermined first storage portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a sheet conveying portion which conveys sheets;
an execution processing portion which executes image forming processing for forming a page image on each of the sheets sequentially conveyed by the sheet conveying portion;
an acquisition processing portion which acquires an ink consumption used for forming the page image for each of the page images formed by the image forming processing; and
a storage processing portion which stores the ink consumption acquired by the acquisition processing portion in a predetermined first storage portion.

2. The image forming apparatus according to claim 1, comprising:
a plurality of nozzles which discharge ink droplets onto the sheet conveyed by the sheet conveying portion; and
a count processing portion which counts a number of times of discharge of the ink droplets of each of the nozzles during a forming period of the page image, wherein
the acquisition processing portion acquires the ink consumption based on a result of the count by the count processing portion.

3. The image forming apparatus according to claim 1, comprising:
a sheet discharge portion onto which the sheet on which the page image has been formed is discharged, wherein
the storage processing portion stores the ink consumption corresponding to the sheet for which the image forming processing has been interrupted before being discharged onto the sheet discharge portion in a second storage portion different from the first storage portion.

4. The image forming apparatus according to claim 1, comprising:
a login processing portion which causes users to log in, wherein
the first storage portion is provided for each of the users who are capable of logging in to the image forming apparatus, and
the storage processing portion stores the ink consumption acquired by the acquisition processing portion in the first storage portion corresponding to the user who is currently logged in.

5. A storage method executed in an image forming apparatus including a sheet conveying portion which conveys sheets, comprising:
an execution step of executing image forming processing for forming a page image on each of the sheets sequentially conveyed by the sheet conveying portion;
an acquisition step of acquiring an ink consumption used for forming the page image for each of the page images formed by the image forming processing; and
a storage step of storing the ink consumption acquired in the acquisition step in a predetermined first storage portion.
